(19) United States
(12) Patent Application Publication
(10) Pub. No.: US 2012/0047062 A1
(43) Pub. Date: Feb. 23, 2012

(54) EXCHANGE TRADED INSTRUMENTS DIRECTED TO MANAGING RISK

(76) Inventor: Geoff D. ROBINSON, Chicago, IL (US)

(21) Appl. No.: 13/214,692

(22) Filed: Aug. 22, 2011

Related U.S. Application Data
(60) Provisional application No. 61/376,125, filed on Aug. 23, 2010.

(51) Int. Cl. G06Q 40/00

(52) U.S. Cl. 705/37; 705/35

(57) ABSTRACT

The invention relates generally to an exchange traded debt instrument including underlying instruments for managing default risk. The debt instrument allows borrowers and lenders to come together in a futures-style exchange. The exchange acts as a counterparty to all transactions on the exchange thereby transferring default risk from lenders to the exchange.

### PRIORITY CLAIM

This Application claims the benefit of Provisional U.S. Patent Application Ser. No. 61/376,125 filed Aug. 23, 2010.

### FIELD OF THE INVENTION

The invention relates generally to electronic trading systems for exchange trading of instruments over an electronic trading network. More particularly, the invention relates to exchange trading of an instrument directed to one or more debt obligations between one or more participants in order to manage default risk.

### BACKGROUND OF THE INVENTION

The term “debt” typically refers to one or more assets that is owed. Debt is created when a lender or creditor agrees to lend one or more assets to a borrower or debtor. Assets may be any item such as currency or money, stocks, bonds, commodities, notes, mortgages, property, etc.

Traditionally, lenders and borrowers are directly associated with one another, even when transactions are facilitated by a financial intermediary. The borrower initially receives (or borrows) an asset, called the principal, from the lender. The borrower is obligated to return the asset to the lender at a later time. Typically, the asset is money such that the lender lends a certain amount of money to the borrower—generally referred to as a loan. The borrower is obligated to pay back an equal amount of the money. The loan is usually provided at a cost to the borrower, referred to as interest. The amount of interest a lender requires from a borrower may be arbitrary or calculated based on the risk associated with the borrower's likelihood of failure to repay the loan.

Often a lender transfers their rights to a third party, for example, a lender transfers the loan to the third party through a sale of the loan. In this instance, the borrower's obligation is to pay back the money to the third party and the third party assumes any risk that the borrower may fail to repay the loan. As such, it is important that the third party understands the risk involved before buying a given loan from a lender.

Debt obligations are usually based on an asset (currency, stocks, bonds, commodities, notes, mortgages, property, etc.) on which the cash flow is based, although debt obligations may also be based on an externally referenced product, index, market, or price. While some obligations such as bonds and loans allow lenders to transfer their rights to a third party, other obligations do not allow for such transfer. In any case, at any given time a specific lender is associated with a specific borrower.

A traditional exchange market is the forum of an organized marketplace for buyers and sellers of listed financial instruments to come together to trade those financial instruments. The instruments are bought and sold on a price determined through supply-demand mechanisms. More generally, an exchange market is an example of a financial market. A financial market is defined by the collective action of market participants pursuing the trade of certain financial instruments.

A financial instrument may be directed to debt. In this instance, the financial instrument includes one or more terms related to the debt. Such terms include details related to the promise to repay the debt, including for example: borrower's total amount owed, percentage interest rate if applicable, maturity date on which the instrument settles, timing and amount of payments required from the borrower to the lender. Typically, the borrower's obligation is to pay back the money in regular installments, or partial repayments, on or before a specified date. The exchange market establishes a structured environment where debt may be traded with ease between interested participants.

Financial markets may sometimes be referred to by other names based on the types of financial instruments that are traded. For example, in the event that the market deals mainly with the trading of long term municipal and corporate bond issues, the financial market may be known as a bond market. If short term notes are the main focus of trading, the financial market may be known as a credit market. Such markets may collectively be known as a fixed income market.

More specifically, the New York Stock Exchange (“NYSE”) Bonds Trading Platform and the Chicago Mercantile Exchange (“CME”) U.S. Treasury Futures are exchange markets that facilitate the transfer of rights for pre-existing cash flow arrangements such that the exchange market uses pre-existing obligations as deliverable goods. The CME Eurodollar Futures, the Chicago Board of Trade (“CBOT”) Interest Rate Swaps, and the Eris Exchange Interest Rate Swap Futures are exchange markets that use an external reference price or market price to determine the cash flows of a cash-settled contract.

Traditional exchange markets do not permit the transfer of cash flow liabilities. Since the credit of the borrower is typically at issue, lenders do not permit a borrower to transfer their debt obligation to another party—only lenders are able to transfer cash flow rights on the exchange (e.g., bond trading).

In a fixed income market, in order to streamline the transfer of obligations, multiple obligations are often packaged together and sold as a group under a special purpose instrument. Such instruments are commonly referred to as asset-backed securities. The process of packaging obligations into special purpose instruments for the purpose of redistribution is called securitization.

While the layer of abstraction added by this securitization approach makes the mechanics of buying and selling large quantities of obligations easier, the risk that the obligations may not be repaid is still associated with the specific underlying borrowers. Further, as packaging together multiple obligations becomes more and more complex, it becomes increasingly difficult for lenders to know who is ultimately responsible for the debt underlying the instrument and consequently how much risk is involved.

This complexity and lack of transparency of such financial instruments is widely cited as one of the causes of the recent financial crisis and economic downturn which started in 2007. The financial crisis is a real world illustration of why it is desirable to readily know who is ultimately responsible for the obligations underlying the financial instruments that are bought and sold on exchange markets. Currently available instruments fail to provide such transparency.

Therefore, there is a demand for exchange trading of an instrument directed to one or more debt obligations that allows a borrower to transfer their obligation to another party as well as allow the exchange to act as a counterparty to all participants, thereby securitizing debt obligations and permitting lenders to remain insulated from the credit risk of any specific borrower. The invention satisfies this demand.

### SUMMARY OF THE INVENTION

The exchange tradable instrument of the invention is an instrument directed to one or more debt obligations, herein referred to as a “debt instrument”. The debt instrument includes underlying instruments and allows debtors (also referred to herein as “borrowers”) and creditors (also referred to herein as “lenders”) to come together in a futures-like exchange. The exchange clearinghouse acts as a counterparty to all transactions on the exchange thereby intermediating the default risk of debtors for the benefit of creditors. Cash flow obligations of the debt instrument are created by the act of trading on the exchange—the cash flow obligation is not based on an externally referenced product, index, market, or price.

The debt instrument provides debt securitization, where the debt obligation of any specific debtor is securitized broadly across all creditors on the exchange, specifically through the exchange clearinghouse.

For example, a mortgagee wishes to sell a mortgage to the market. In other words, the mortgagee wishes to convey the mortgage to the exchange as collateral in order to receive cash. The mortgagee borrows from the exchange (making the mortgagee a borrower), and uses the cash borrowed from the exchange to fund a mortgage. The mortgage asset backs the cash flow obligation the mortgagee has to the exchange. Effectively, every lender in the exchange would own an equal part of this cash flow backed by the mortgage asset. In this example, a mortgage is the asset, however an asset may be any tangible property that may be subject to a loan, such as land, house, jewelry, boats. The invention is discussed herein with respect to mortgages and mortgage assets for exemplary purposes only—any asset is contemplated.

No lender holds the rights to the cash flows of any specific borrower, and no borrower holds an obligation to pay any specific lender. The clearinghouse “passes through” all cash flows from borrowers to lenders. Positions of buying or selling the instruments are not marked-to-market, and no cash flows result from the fluctuation of prices, which is a significant distinction from traditional futures markets.

The exchange clearinghouse manages default risk of borrowers on behalf of lenders. It is contemplated that the clearinghouse may require collateral or otherwise restrict the behavior of borrowers. The clearinghouse may set such restrictions directly with the borrowers or indirectly such as through a network of exchange-sanctioned guarantors with which all borrowers are affiliated.

According to the invention, if a borrower defaults, then the cash flow into the clearinghouse at settlement is reduced, and is less than the cash flow obligation of the clearinghouse to the lenders. To account for such a situation, it is contemplated that the clearinghouse may retain the right to modify the principal cash flow to lenders for an instrument during the settlement process. The clearinghouse may decrease the amount of the principal to be delivered per instrument so that lenders share the burden of default evenly. The clearinghouse may also retain the right to maintain an “insurance pool” to partially or fully cover any reduction in cash flows from borrowers. Such a pool may be funded by fees directly on borrowers, all or a portion of funds collected based on an interest rate, or via a network of guarantors. Lenders on the exchange are able to examine the likelihood of default by borrowers, and transact at prices according to their expectations of default events.

The debt instrument may further include underlying financial instruments, for example a credit derivative instrument or a rate swap instrument. Additional underlying instruments are contemplated, such as asset-class-specific credit derivatives, secondary credit derivatives, and foreign currency instruments, foreign exchange debt instruments.

A credit derivative instrument works in tandem with the debt instrument to provide creditors with a means to adjust default risk exposure according to their investment strategy ranging from conservative to aggressive. A credit derivative instrument may trade on the exchange market that settles based on the reduction noted above—clearinghouse decreased amount of principal delivered—allowing lenders to trade the collective default risk of debtors. Any variations of the credit instrument are contemplated. For example, a credit instrument may trade that settles based on the decreased amount of principal delivered based on a specific subset of borrowers. Another variation may be a credit instrument that settles based on the decreased amount of principal delivered based on a specific subset of assets.

A rate swap instrument is defined in relation to the daily closing prices of both the debt instrument and the credit derivative instrument. Multiple variations of the rate swap instrument are contemplated. In one variation, a rate swap instrument settles periodically, such as daily, in reference to the trade prices of a debt instrument and credit derivative instrument of a similar maturity. In another variation, a rate swap instrument settles at maturity in reference to a debt instrument and credit derivative instrument of a maturity occurring in the future. A rate swap instrument may further include a “strike price”, and settles based on the difference between the strike price and the trade price of a debt instrument or credit derivative instrument on the settlement date. This would allow the trading of “interest rates”, or simply “rates”.

It is contemplated that the several instruments may be further varied through the currencies in which cash flows obligations are settled. In one variation, an instrument may trade and settle on a daily basis in the same currency with which it is settled at maturity, for example, in US dollars. In another variation, an instrument may trade and settle on a daily basis in one currency, for example, in British pound sterling, but settle at maturity in a separate currency, such as Euros. This would allow the trading of debt in various currencies, currency exchange, currency futures, and other foreign exchange market functions.

It is contemplated that the several instruments may be traded stand-alone or in combinations. For example, instruments from various series may be combined, so as to be quoted and traded for a single price. As another example, a combination may be created from a large lot of a ten-year issue with several small lots in each yearly issue of the same month such as to create a “ten year bond with annual coupon payments”. As another example, any combination of instruments may be strung together to create a swap—a derivative in which counterparties exchange certain benefits of one party's debt instrument for those of the other party's debt instrument.

For purposes of this application, the term “party”, “parties”, “participant”, or “participants” includes one or more buyer, seller, and may be a private individual, a business, or a legal entity, for example, a trust. For purposes of this application, the parties are described in reference to a lender (otherwise referred to herein as a “buyer”) and to a borrower (otherwise referred to herein as a “seller”). A “buyer” is generally the party owing money immediately upon execution of a trade, while a “seller” is generally the party receiving money immediately upon execution of a trade. The term “debt obligation” generally identifies any item that is owed by one party to another party. For purposes of this application, the term “item” is discussed herein with reference to currency or money, but any “item” is contemplated such as stocks, bonds, commodities, notes, mortgages, property, etc.

It is an objective of the invention to allow multiple borrowers and multiple lenders to come together on the same exchange.

It is another object of the invention to provide a debt instrument that allows borrowers to transfer cash flow liabilities.

It is another object of the invention to provide the exchange (specifically its clearinghouse) to function as a counterparty to all borrowers thereby allowing a trade to effectively transfer one borrower's obligations to another.

It is another object of the invention to insulate lenders from the credit risk of any specific borrower.

It is a further objective of the invention to allow the exchange to manage risk by employing collateral requirements on parties.

It is a further objective of the invention to allow parties to manage various risks associated with a debt instrument by trading additional instruments which reference said debt instrument.

It is recognized that the invention may be carried out on computer hardware and/or networks.

These and other aspects, features, and advantages of the invention will become more readily apparent from the attached drawings and the detailed description of the preferred embodiments, which follow.

### DESCRIPTION OF THE DRAWINGS

The invention may be better understood by reading the following detailed description of certain preferred embodiments, reference being made to the accompanying drawings in which:

FIG. 1 illustrates an exemplary electronic trading network according to one embodiment of the invention;

FIG. 2 illustrates a diagram of a relationship between a lender, a borrower and an exchange clearinghouse according to one embodiment of the invention;

FIG. 3 illustrates a diagram of a relationship between a lender, a borrower and an exchange clearinghouse according to another embodiment of the invention;

FIG. 4 illustrates a diagram of a lender selling a debt instrument to another lender according to another embodiment of the invention;

FIG. 5 illustrates a diagram of a borrower transferring debt to another borrower according to one embodiment of the invention;

FIG. 6 illustrates a debt instrument according to one embodiment of the invention;

FIG. 7 illustrates a credit derivative instrument according to one embodiment of the invention;

FIG. 8 illustrates a debt instrument and a credit risk instrument combination according to one embodiment of the invention;

FIG. 9 illustrates a rate swap instrument according to the invention;

FIG. 10 illustrates a diagram of the debtor default loss structure of the exchange market according to one embodiment of the invention;

FIG. 11 illustrates the overall market structure, showing the relationships between the functional units of the exchange and its participants, capital flows, and investment returns according to one embodiment of the invention; and

FIG. 12 illustrates a flow chart according to a method for creating an instrument according to one embodiment of the invention.

### DETAILED DESCRIPTION OF PREFERRED EMBODIMENTS

The invention is directed to a debt instrument including underlying instruments referred to herein as a credit derivative instrument and a rate swap instrument. Each debt instrument, credit derivative instrument and rate swap instrument includes a maturity date.

The maturity date is the terminal date of the contract—the last date on which the instrument may be freely traded on the exchange. For purposes of the application, the instruments discussed below each include a single, common maturity date. It is contemplated that variations of the debt instrument and its underlying instruments may have their own unique maturity dates. A maturity group is one or more instruments (debt instrument and each underling instrument) with a common maturity on a specific date.

For example, a maturity group may be one or more instruments that share the same maturity date during a specific month (i.e., a debt instrument and credit derivative instrument each have a maturity date of January 15). Each maturity group is referred to by month and year such as: “June 2010 debt instrument”, the “August 2013 risk-free combo”, or the “February 2037 maturity group”.

Maturity groups may defined according to an ongoing basis. For example, starting with the current date, each maturity group going forward is tradable. If the current date is Apr. 20, 2010, then the May 2010, June 2010, July 2010, etc., maturity groups are all tradable. This continues out to some terminal maturity date. When a maturity date passes, a new terminal maturity group is created for the month following the existing terminal maturity, so that the same number of maturity groups are always tradable.

Trading occurs within trading days, or sessions. That is, there is a daily open for the exchange, and a daily close. Each instrument has daily close prices which are quoted on the exchange. The close price is generally derived from the last executed trade, quoted price, or implied price for the particular instrument. Whatever the derivation, it should be thought of as “the prevailing trade price at the close of the trading day”. Underlying instruments to the debt instrument—specifically, rate swap instruments—have cash flows that are defined in terms of the daily closing prices.

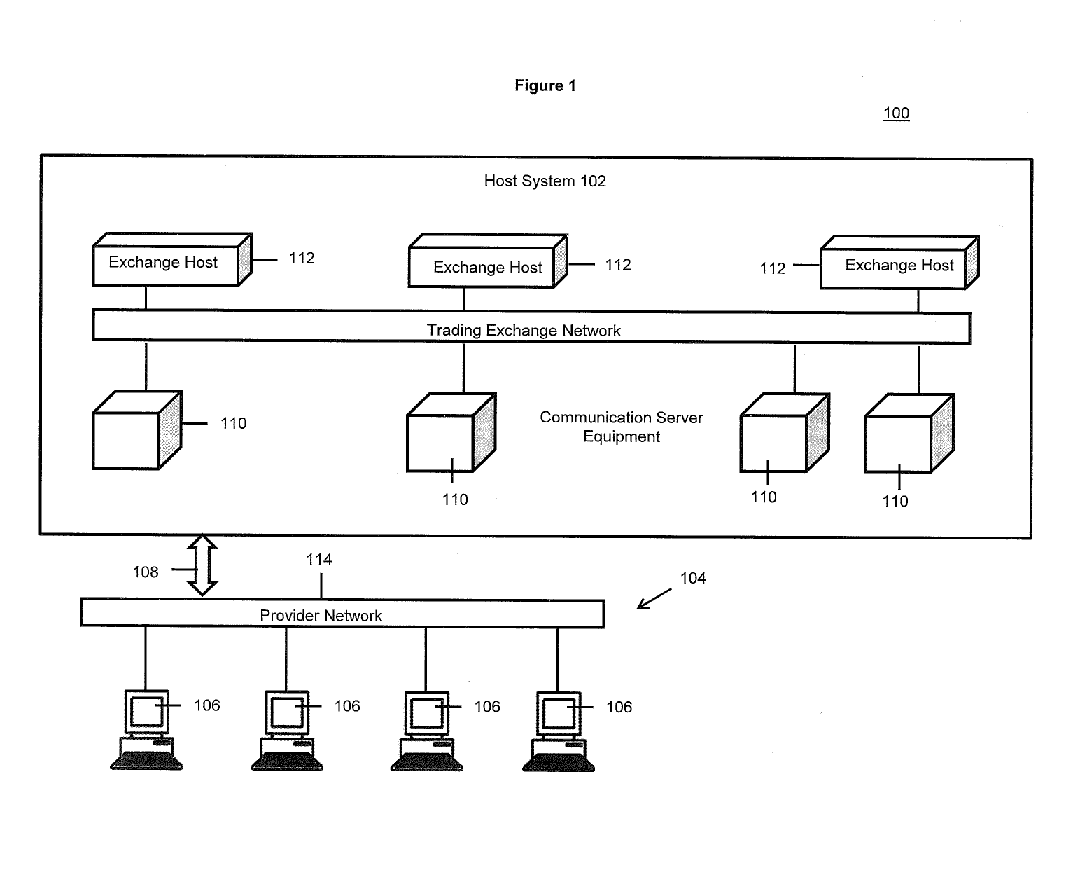

FIG. 1 is a diagram of an exemplary electronic trading network 100 including a trading exchange host system 102 and a trading firm system 104 having one or more client devices 106. Client devices 106 are communicatively coupled, either directly or indirectly, to one or more trading exchange markets. To facilitate greater mobility, the client device may be handheld and include any small-sized computing device including a user interface with a display screen. Examples of such devices include a personal digital assistant (“PDA”), smart hand-held computing device, cellular telephone, or a laptop or netbook computer, hand held console or MP3 player, tablet, or similar hand held computer device, such as an iPad®, iPad Touch® or iPhone®.

The network 100 includes a trading exchange host system 102 and a trading firm system 104 having a number of client devices 106. The host system 102 is operatively coupled to the trading firm system 104 via at least one communication link 108 such as a link connecting a host network router and at least one trading firm network router. The communication link 108 may be one of any number of suitable communications links such as, for example, a LAN, a WAN, the Internet, etc., to allow communication between the client devices 106 and the trading exchange host system 102. Although only one trading exchange host system 102 and one trading firm system 104 are illustrated in FIG. 1, it should be understood that additional trading exchange host systems 102 and/or additional trading firm systems 104 may be included in the electronic trading network 100.

The host system 102 includes a number of trading exchange hosts 112 configured to enable execution of trade orders placed by participants through the client devices 106. The host system 102 also includes communication server equipment 110 configured to distribute trading exchange host 112 data to trading firm system 104 and forward incoming trade orders to the trading exchange host system 102, and the communication link 108 configured to route incoming and outgoing data to and from the host system 102. Although FIG. 1 illustrates the electronic trading network 100 with three trading exchange hosts 112, four communication servers 110, and one communication link 108, it is contemplated that the host system 102 may be one of any number of suitable configurations to enable electronic trading. The trading firm system 104 includes a provider network 114 operatively coupled to the host system 102 via the communication link 108. As illustrated, the client devices 106 are operatively coupled to the provider network 114 using well known means (e.g., a LAN, a WAN, wireless networks, Internet). Although only four client devices 106 are illustrated, it should be understood that any number of client devices 106 may be included in the trading firm system 104. The client devices 160 are configured to enable electronic trading by one or more traders—either associated with an on-line broker, trading firm, investment bank, a clearing house or any corporation involved in electronic trading, to name a few. The trading firm system 104 is configured to enable a trader via a client device 106 to place a trade order for a debt instrument on an electronic market of the electronic trading network 100. It is contemplated that a database (not shown) is included in the provider network 114, and is configured to maintain data associated with trade orders, executed trade orders, user configurations, and market prices, etc.

The exchange clearinghouse defines several classes of participants. This is necessary because participants with different net positions in the various instruments have differing risk management requirements. Although net positions may vary between participants, the invention considers participant classes for each side of a trade, as a reference.

The participant classes are debtors, creditors, leveraged creditors, and guarantors.

Debtors are participants who have a net short position in the debt instrument. Creditors are participants who have a net long position in either the debt instrument or credit derivative instrument. Leveraged creditors are participants who have a net short position in the credit derivative instrument, which partially funds their net long debt instrument positions. Guarantors are agents of the exchange clearinghouse and underwrite debtors' short positions.

Additional restrictions may apply, as determined by the rules of the exchange. For example, a participant may not be allowed to be both a debtor in the debt instrument and a leveraged creditor in the credit derivative instrument within the same maturity group (although this may be allowed across maturity groups). Like futures contracts, these debt instruments are created through the act of trading in a continuous auction format. When a trade is recorded on the exchange, the participants take offsetting positions, where one participant becomes the instrument buyer, and the other becomes the instrument seller. Trades for a participant aggregate, so that their overall net position reflects the sum total of their trades. Participants may trade with each other in myriad ways, but the overall combined net position of all participants is always zero for each instrument.

Trades occur as the result of orders from participants, which are submitted electronically to the exchange matching engine. The information for every order consists of the order type, the instrument to be traded, the amount of the instrument to be traded, and the identification of the submitting participant. The amount to be traded is called the size of the order, and must be a whole number (it is not possible to trade fractions of contracts). Participants may place three types of orders: market orders, limit orders, and execute-at-close orders.

A market order is an order to buy or sell an instrument for the best price available. The order is immediately matched against the best available opposing order(s) and assigned a trade price.

A limit order is an order to buy or sell an instrument at a specified limit price. The matching engine attempts to match the order immediately at the specified price (or better). If the order can't be matched, it is held over in the order book to be matched against a future order(s).

An execute-at-close order is a variant of the market order. Rather than being executed immediately, it is held aside until the close of the specified trading day. Once a closing price for that trading day is determined, the execute-at-close orders are matched as part of the daily settlement procedure, where the closing price for the instrument is used as the trade price.

An incoming order is called a working order. Working orders are sent to the matching engine, which attempts to match working orders against each other and against the existing order book. Working orders that cannot be matched become standing orders and are added to the order book. The order book for an instrument consists of all standing orders for that instrument. Unmatched standing orders may be cancelled by the submitting participants.

An order that has been matched and executed is called a filled order. An order may be partially matched such that only a portion of its size remains outstanding. Such standing orders are called partially filled orders. An order terminated by the submitting participant is called a cancelled order. An order terminated directly by the exchange for some reason is called a killed order.

The simple orders defined above are for trading individual instruments. It is sometimes useful, however, for participants to trade multiple instruments simultaneously. Complex orders exist to provide this function.

A complex order is a market, limit, or execute-at-close order that consists of at least two legs. Each leg of the complex order is for a particular amount of an individual instrument. In other words, each leg has its own individual size and buy/sell side. However, there is a single trade price set for the overall complex order. For example, a complex limit order may have three legs, but the limit price is set in proportion to the combined net trade prices of the legs. Complex orders are said to be orders for complex instruments.

A standard complex instrument is the “risk-free combo”, which is long one contract each of the debt and credit derivative instruments in the same maturity group. This is also known as the synthetic risk-free instrument.

In general, participants may define arbitrarily complex instruments, in any combination of buy and sell legs, and then submit orders for those instruments. The complex orders may either be matched directly to similar complex orders or its legs may be individually matched to the underlying simple order books.

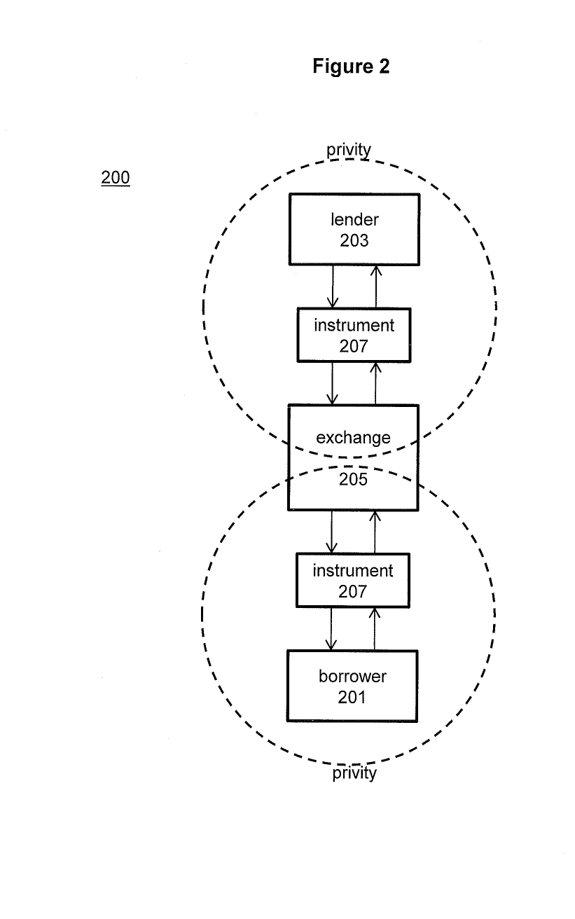

As shown in FIG. 2 a system 200 according to the invention comprises a borrower 201, a lender 203, and an exchange 205. The system 200 further comprises a debt instrument 207, which creates an obligation for the borrower 201 to pay the exchange 205 and the exchange 205 to pay the lender 203. However no obligation is created between the borrower 201 and the lender 203. As a result, all obligations are paid by or paid to the exchange 205, thereby making the exchange 205 a counterparty to all transactions on the exchange 205. It is contemplated that multiple borrowers and multiple lenders may come together on the same exchange 205. Furthermore, the number of borrowers 201 and the number of lenders 203 need not be symmetrical.

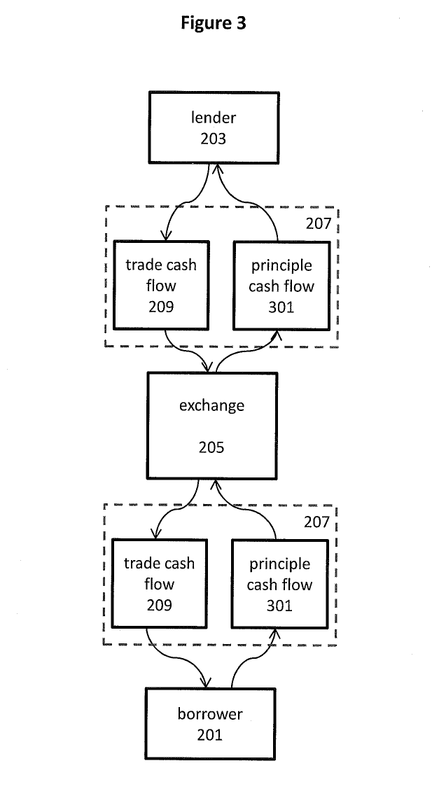

FIG. 3 illustrates a diagram of the cash flow of a debt instrument according to one embodiment of the invention. As shown, the borrower 201 takes on debt by selling its obligation to the exchange 205 in the form of a debt instrument 207. The lender 203 becomes a party by purchasing the debt instrument 207 from the exchange 205. The lender 203 pays to the borrower the trade cash flow 209 immediately in exchange for the exchange's obligation to pay the principal cash flow 301 at a future maturity date. The borrower 201 receives the trade cash flow 209 immediately, in exchange for its obligation to pay the principal cash flow 301 at the future maturity date.

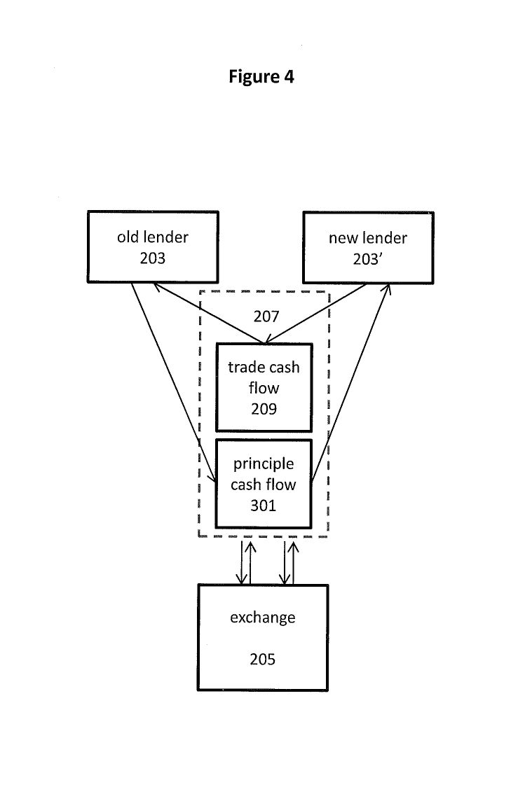

FIG. 4 illustrates a diagram of a lender selling a debt instrument to another lender according to another embodiment of the invention. A first lender 203 may sell the debt it is owed 207 to a second lender 203′. To effectuate this transfer, the second lender 203′ pays the trade cash flow 209 to the exchange 205 which in turn immediately pays it to the first lender 203. At the same time, the first lender 203 transfers the exchange's obligation to pay the principal cash flow 301 back to the exchange 205 which in turn immediately pays it to the second lender 203′.

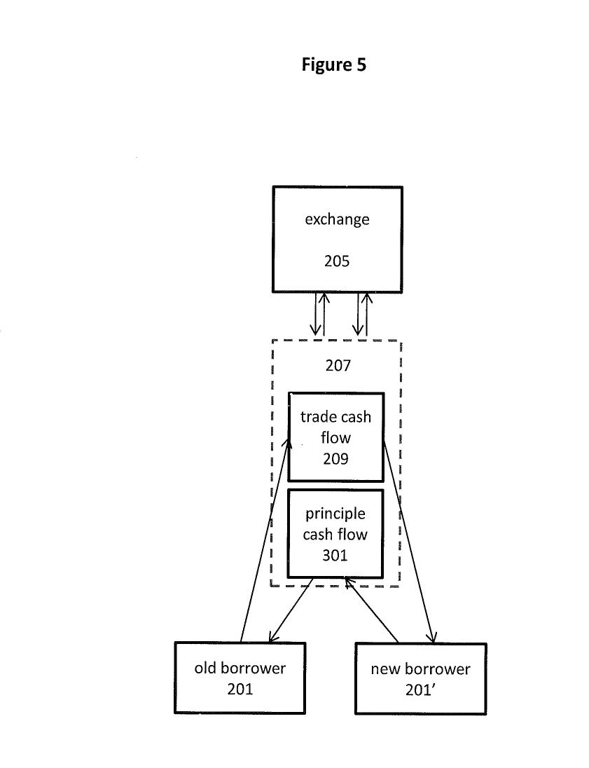

Likewise, as illustrated in FIG. 5, a first borrower 201 may transfer its payment obligation to a second borrower 201′. To effectuate this transfer, the first borrower 201 pays to the exchange 205 the trade cash flow 301 and the exchange 205 in turn pays to the second borrower 201′ the trade cash flow. The first borrower 201 is released from its obligation to pay the principal cash flow 301 which is transferred via the exchange 205 to the second borrower 201′.

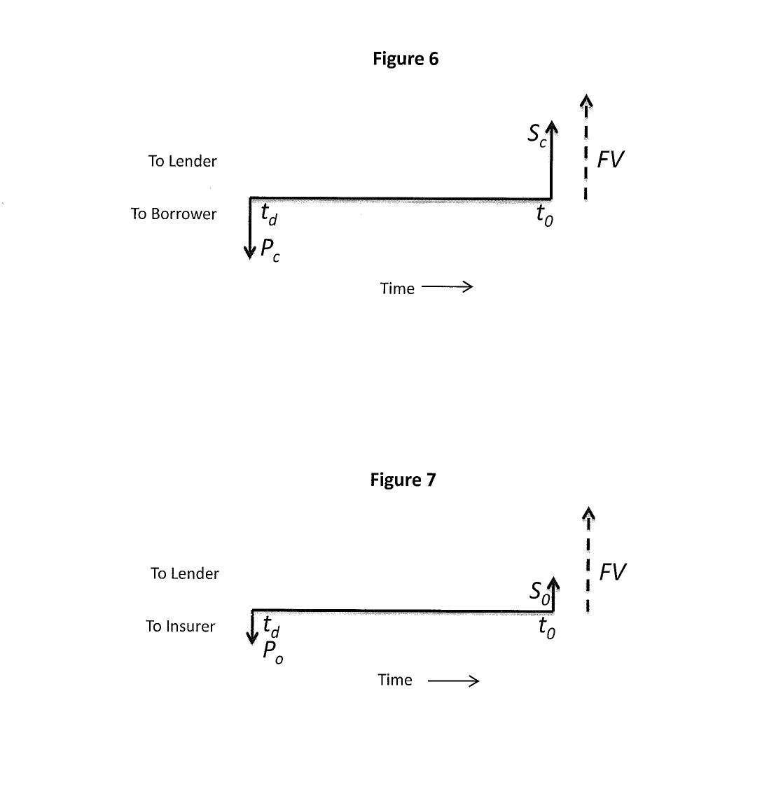

Multiple embodiments of the debt instrument 207 may be traded via the exchange 205. As shown in FIG. 6, the debt instrument relates to a cash loan and is defined by two cash flows, a trade cash flow—or trade price P_{c}—and a principal cash flow, also known as the face value FV. The debt instrument has a trade date t_{d} as well as, a maturity date t₀. Lenders pay to the exchange the trade price P_{c} in return for the exchange's obligation to pay the lender a settlement value S_{c} on the maturity date t₀. The exchange pays the trade price P_{c} to the borrower in return for the borrower's obligation to pay the principal cash flow FV at the maturity date t₀. The trade cash flow P_{c} is the price of the debt instrument at any given time and is determined by the market. The settlement value S_{c} is the principal cash flow (face value) FV minus any loss created by a defaulting borrower; in other words the amount actually paid back to the exchange by one or more borrowers.

Where multiple lenders exist, the risk of default is spread out across the parties. Even though the risk of default is spread out across a group of lenders, it is still essential that risks be managed. It is therefore the responsibility of the exchange to ensure that overall risk levels are optimal and that the borrowers are well behaved. The exchange has multiple ways to do this; including: reducing the risk that a borrower may default on the principal, ensuring that in the case of default, some percentage of the principal is repaid, and ensuring that failed borrowers are “gracefully retired”.

The exchange may use collateral requirements and monitoring of borrowers to manage risk. In one embodiment, the exchange defines asset classes and ensures that each debt instrument is collateralized by assets of a particular class. The collateral requirements vary based on the asset class and borrower; however, the marginal collateral requirement may be generalized by the following exponential equation where m is the minimum collateral percentage, n is the outstanding balance, g is the growth coefficient, and q is the position limit control:

marginal collateral requirement=m+e^{g(n-q)}

The minimum collateral percentage m is the basic control for collateral requirements and q is the basic control for position limits. According to the equation above, the position control limit q controls the economic equilibrium for the outstanding balance n. For example, if the position control limit q is high, then the marginal collateral requirement does not start moving away from the baseline m until the outstanding balance n gets large. In the alternative, if the position control limit q is small, then the marginal collateral requirement starts moving away from the baseline m immediately.

The total required collateral would be the sum of marginal collateral required for each dollar borrowed. The total required collateral may be represented by the following equation where d is the dollar borrowed and m is the marginal collateralization for that dollar.

(d₁×m_{d}_{₁})+(d₂×m_{d}_{₂})+(d₃×m_{d}_{₃}) . . . +(dₙ×m_{d}_{ₙ})

By manipulating the minimum collateral percentage, the growth coefficient, and the position limit control, the exchange may control risk through the collateral requirements. The minimum collateral percentage sets a minimum collateral requirement for every dollar borrowed. The position control limit sets the dollar point at which the minimum collateral requirement is no longer sufficient. And, the growth coefficient determines how quickly the marginal collateral requirement grows after the position control limit is reached.

At some point, the required collateral for a given dollar amount exceeds the marginal benefit accruing to the borrower from the borrowing activity. This collateralization requirement effectively limits the amount of money a borrower may borrow to a finite amount.

FIG. 7 illustrates a credit derivative instrument according to the invention. The credit derivative instrument, specifically a credit risk instrument, is a derivative of the first debt instrument. The credit risk instrument is defined by two cash flows, a trade cash flow Pₒ and a settlement cash flow Sₒ, with a maturity date t₀ that matches its corresponding debt instrument. The settlement cash flow Sₒ is defined as the difference between the principal cash flow, or face value FV, and the settlement cash flow Sₒ of the corresponding debt instrument. The trade cash flow Pₒ is the price of the credit risk instrument at any given time and is determined by the market.

The credit risk instrument and its underlying debt instrument act in tandem to provide a guaranteed fixed payment equal to the face value specified by the debt instrument. Therefore, a lender holding both a credit risk instrument and its underlying debt instrument is not exposed to default risk.

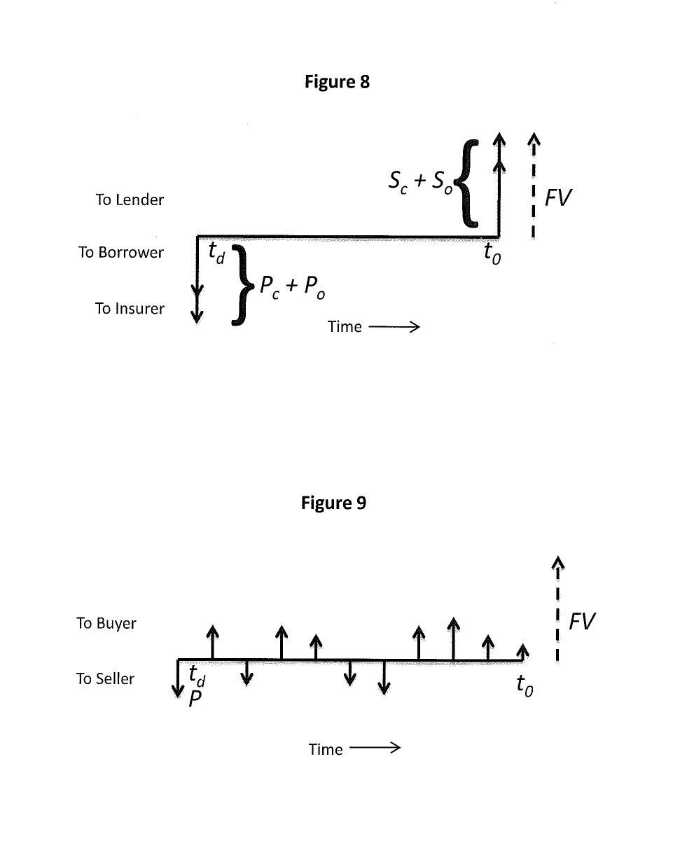

FIG. 8 illustrates a debt instrument and a credit risk instrument combination according to the invention. A debt instrument and a credit risk instrument with the same face value and maturity date may be bundled together to create a risk free asset or risk free combination. The bundle allows a debt instrument and a credit risk instrument to be bought and sold together at a single price.

FIG. 9 illustrates a rate swap instrument according to the invention. The rate swap instrument is an agreement between two participants and the exchange clearinghouse. The instrument is defined in relation to the daily closing prices of both the debt and credit derivative instruments. The clearinghouse acts to clear all cash flows. Immediately upon the creation of the contract, the link between the participants is broken, and the clearinghouse becomes the counterparty to both participants.

The rate swap instrument is defined by a series of cash flows. The trade cash flow is given by the trade price, p_{S}. The daily cash flows are given by dₙ, where n is the number of days until the maturity date. The trade price occurs immediately upon execution of the trade at time t_{d}, while the daily cash flows occur after close as part of the daily settlement operations for the exchange.

The instrument is further specified by a face value, FV, and a maturity date. The face value, or principal amount, is a pre-specified, fixed amount, equal to the face value of the debt instrument. The face value of the rate swap instrument is also referred to as its notional value. The final trading day is the maturity date of the instrument.

The daily cash flows for this instrument are defined in relation to the daily closing prices of the debt and credit derivative instruments.

At the close of each trading day, a swap rate is determined from the risk-free (combo) closing price, p_{f}, which is defined as the sum of the closing prices of the debt and credit derivative instruments:

p_{f}=p_{d}+p_{c}

The swap rate, y_{S,n}, is set such that it satisfies the following formula:

p_{f}=f/(1+y_{Sn}/365)ⁿ

The daily settlement cash flow, dₙ, is then calculated based on the difference between the current swap rate, y_{S,n}, and the previous trading day's swap rate, y_{S,n+1}:

d₀=(y_{S,n}−y_{S,n+1})*k_{S}

Where k_{S} is a fixed scaling factor converting from percentage terms to currency terms. For example, k_{S} might be $0.01 per basis point.

The final obligation is the daily cash flow on the second to last trading day, t₁. There is no daily cash flow for the final trading day because there is no interest rate risk on this day—the closing price is always the face value, f. That is, d₀=0.

Each day, one participant will receive the settlement cash flow while another pays the settlement cash flow. The buyer of the rate swap is the participant who receives the cash flow for increases in the swap rate, and the seller is the participant who receives the cash flow for decreases in the swap rate. The buyer is long the rate swap, while the seller is short the rate swap.

The daily settlement cash flow, as defined, is the amount paid to the buyer. This can be a negative value, meaning that the buyer will pay the seller on such days. There are no other settlement cash flows defined for the rate swap instrument.

Multiple contracts can be exchanged in a single trade. Contracts are traded in whole number lots, where the aggregate face value of the contracts traded is the simple multiple of the face value specified for a single contract. Prices are quoted in the market in terms of individual contracts.

The debt instrument is a contractual agreement between creditors, debtors, and the exchange clearinghouse. The creditor lends some amount of capital to the debtor, who in turn promises to repay a fixed principal amount to the creditor in the future. This is similar to a zero-coupon bond contract. The clearinghouse acts to clear all cash flows. Immediately upon the creation of the contract, the link between the creditor and debtor is broken, and the clearinghouse becomes the counterparty to both participants.

The debt instrument is defined by two cash flows, a trade cash flow given by the trade price, p_{D}, and a settlement cash flow given by the settlement price, s_{D}. The trade price occurs immediately upon execution of the trade at time t_{d}. The settlement cash flow occurs during the settlement period following the close of the final trading day at time t₀. The settlement price is determined by the exchange during the settlement period.

The instrument is further specified by a face value, f, and a maturity date. The face value, or principal amount, is a pre-specified, fixed amount. The final trading day is the maturity date of the instrument.

The trade price is not specified. It is determined by the participants in the market who quote and trade the instrument according to the rules of the exchange. This is “the market price” of the instrument.

Multiple contracts may be exchanged in a single trade. Contracts are traded in whole number lots, where the aggregate face value of the contracts traded is the simple multiple of the face value specified for a single contract. Prices are quoted in the market in terms of individual contracts.

The settlement price is determined by the exchange, based on the default rate of debtors. During settlement, debtors are obligated to repay the full face value of the contract. It is possible, however, for debtors to default on this obligation. A debtor may pay a portion of their obligation, or none of it.

The exchange aggregates all repayments from all debtors into a single account. It then distributes the cash from this pool to all creditors in proportion to the face value of the contracts each hold. That is, each creditor receives the same percentage of the face value which they are owed. The amount paid for a creditor holding a single instrument is the settlement price. In other words, a creditor receives the settlement price.

Creditors are said to be the buyers of the instrument, or long the contract. Debtors are said to be sellers of the instrument, or short the contract.

The debt instrument is US dollar denominated. Participants, however, may be interested in the ability to transact in additional currencies. An extension of the basic debt instrument may provide this function.

In this scenario, a foreign currency debt instrument would be created so that all transactions for that instrument occur in the foreign currency. This instrument is otherwise identical to the standard debt instrument. Likewise, foreign currency credit derivative and rate swap instruments would be linked to this debt instrument. Foreign currency denominated asset classes and collateral requirements would also be defined. This makes all functions of the instrument available to foreign currency users.

Foreign exchange debt instruments are another potential extension. Unlike foreign currency instrument, foreign exchange instruments are defined in terms of two currencies, where all exchange market transactions occur in one currency, and all settlement operations occur in another. In other words, the instrument trade price is denominated in the first currency, but the principal repayment settlement price is denominated in the second. This design creates the basic building blocks for using the exchange as currency trading platform.

For example, a “US Dollar/Euro” debt instrument would trade in US dollars, but its face value would be defined in terms of Euros. All settlement activity would occur in Euros, so that a creditor who paid dollars to purchase the instrument would receive some amount of Euros upon maturity. In this example, the trade currency is US dollars, and the settlement currency is Euros.

Foreign exchange debt instruments do not imply that the exchange must make changes to its collateral system. Suppose that all asset classes are US dollar denominated. In this scenario, it is still possible to have foreign exchange debt instruments. The only caveat is that they must all be defined so that settlement currency is US dollars. The trade currency is not restricted.

This instrument, on its own, involves the transfer of capital in both the trade currency and settlement currency. It is essentially a combination of a debt vehicle with a foreign currency forward contract. This may be useful in and of itself, but the foreign currency debt instrument is particularly useful in combination with other instruments.

For example, a participant may create a straight currency exchange by buying the core, US dollar denominated debt instrument and selling a “Euro/US Dollar” debt instrument of equal face value. The cash flows from settlement exactly offset, so that the participant has effectively sold Euros for dollars in a standard currency transaction. In general, any two currencies may be exchanged in this manner. Currency forward contracts may be similarly arranged via offsetting trade cash flows.

The credit derivative instrument is an agreement between creditors, leveraged creditors, and the exchange clearinghouse. It is defined in relation to the debt instrument. Specifically, it has a settlement price which is defined as the difference between the face value and the settlement price for the debt instrument in the same maturity group. The clearinghouse acts to clear all cash flows. Immediately upon the creation of the contract, the link between the creditors is broken, and the clearinghouse becomes the counterparty to both participants.

The credit derivative instrument is defined by two cash flows, a trade cash flow given by the trade price, p_{C}, and a settlement cash flow given by the settlement price, s_{C}. The trade price occurs immediately upon execution of the trade at time t_{d}. The settlement cash flow occurs during the settlement period following the close of the final trading day at time t₀.

The instrument is further specified by a face value, f, and a maturity date. The face value, or principal amount, is a pre-specified, fixed amount, equal to the face value of the debt instrument. The final trading day is the maturity date of the instrument.

Multiple contracts may be exchanged in a single trade. Contracts are traded in whole number lots, where the aggregate face value of the contracts traded is the simple multiple of the face value specified for a single contract. Prices are quoted in the market in terms of individual contracts.

The clearinghouse guarantees the cash flows for the credit derivative instrument during the settlement period. If a creditor fails to meet its cash flow obligation, the clearinghouse makes up the difference. Creditors always receive the full settlement price of the instrument.

The debt and credit derivative instruments act in tandem to provide a creditor a guaranteed fixed payment equal to the face value specified by each. That is, a creditor holding both instruments is not exposed to default risk.

Creditors are said to be the buyers of the instrument, or long the contract. Leveraged creditors are said to be sellers of the instrument, or short the contract.

The core credit derivative and debt instruments work in tandem to provide creditors with a means to calibrate their default risk exposures to their own taste. These instruments take a “whole market” approach—any default that occurs in any asset class impacts both instruments. There is no distinction between different sources of default impacting settlement prices.

Some participants may wish to have finer control over their default exposure. One solution may be to create a series of credit derivative instruments where each instrument has exposure to a different subset of asset classes. This may be thought of as subdividing the core credit derivative instrument into several distinct sub-instruments. Holding one of each of the asset class specific instruments would be equivalent to holding one contract of the core credit derivate instrument. This is a “vertical slicing” of the core credit derivative instrument. These contracts would allow participants to further control their risk exposures.

A creditor with some inherent excess exposure to a specific asset class may gain a direct, offsetting exposure to the associated default risk. These contracts would also assist the exchange's risk management practices. The market pricing of the various contracts would give some indication of the relative risks of each asset class.

In another variation of the credit derivative instrument, creditors do not necessarily want to hold all of the risk associated with debt instrument default. Extreme default events are necessarily unpredictable and dangerous to front line creditors. Participants may benefit from the ability to transfer excess risk to guarantors, and indeed the exchange may require debtors to purchase protection from guarantors. This may be done through bilateral arrangements, or through an openly traded instrument such as secondary credit derivatives.

A secondary credit derivative is a means for a debtor to buy protection on part of the default risk associated with a specific asset class. In this construction of the exchange, the debtor has purchased (by requirement) excess loss protection from a guarantor, and thus has limited debt instrument exposure to extreme events from the underlying assets. This “horizontal slicing” of the core credit derivative allows the exchange's risk management operation to better control the risk of debtor failure.

The secondary credit derivative also provides a way for the market to price tail risk. Rather than relying on bilateral risk analysis, the real-time pricing of this instrument would be a reliable indication of consensus opinion of risk.

This instrument would provide a safety net to creditors. Consider a scenario in which a creditor is holding a simple leveraged position, where she is long a single debt instrument and short a single credit derivative. In theory, it is possible for her to owe money to the exchange, on net, during the settlement process. This would happen if the default rate for the debt instrument exceeded 50%.

The exchange may eliminate this possibility through rules requiring that debtors buy secondary credit derivative instruments. The loss threshold of the derivatives may then be set so that the worst outcome for a leveraged creditor would be for her to receive no money at settlement. She may never owe additional money, however. This rule would protect the exchange (and other participants) from the credit risk of creditors.

The rate swap instrument is an agreement between two participants and the exchange clearinghouse. It is defined in relation to the daily closing prices of both the debt and credit derivative instruments. The clearinghouse acts to clear all cash flows. Immediately upon the creation of the contract, the link between the participants is broken, and the clearinghouse becomes the counterparty to both participants.

The rate swap instrument is defined by a series of cash flows. The trade cash flow is given by the trade price, p_{S}. The daily cash flows are given by dₙ, where n is the number of days until the maturity date. The trade price occurs immediately upon execution of the trade at time t_{d}, while the daily cash flows occur after close as part of the daily settlement operations for the exchange.

The instrument is further specified by a face value, f, and a maturity date. The face value, or principal amount, is a pre-specified, fixed amount, equal to the face value of the debt instrument. The face value of the rate swap instrument is also referred to as its notional value. The final trading day is the maturity date of the instrument.

The daily cash flows for this instrument are defined in relation to the daily closing prices of the debt and credit derivative instruments.

At the close of each trading day, a swap rate is determined from the risk-free (combo) closing price, p_{f}, which is defined as the sum of the closing prices of the debt and credit derivative instruments:

p_{f}=p_{d}+p_{c}

The swap rate, y_{S,n}, is set such that it satisfies the following formula:

p_{f}=f/(1+yₛₙ/365)ⁿ

The daily settlement cash flow, dₙ, is then calculated based on the difference between the current swap rate, y_{S,n}, and the previous trading day's swap rate, y_{S,n+1}:

dₙ=(y_{S,n}−y_{S,n+1})*k_{S}

Where k_{S} is a fixed scaling factor converting from percentage terms to currency terms. For example, k_{S} might be $0.01 per basis point.

The final obligation is the daily cash flow on the second to last trading day, t₁. There is no daily cash flow for the final trading day because there is no interest rate risk on this day—the closing price is always the face value, f. That is, d₀=0.

Each day, one participant receives the settlement cash flow while another pays the settlement cash flow. Therefore, the buyer of the rate swap is the participant who receives the cash flow for increases in the swap rate, and the seller is the participant who receives the cash flow for decreases in the swap rate. The buyer is long the rate swap, while the seller is short the rate swap.

The daily settlement cash flow, as defined, is the amount paid to the buyer. This may be a negative value, meaning that the buyer pays the seller on such days. There are no other settlement cash flows defined for the rate swap instrument.

Multiple contracts may be exchanged in a single trade. Contracts are traded in whole number lots, where the aggregate face value of the contracts traded is the simple multiple of the face value specified for a single contract. Prices are quoted in the market in terms of individual contracts.

In a financially equivalent variation of the rate swap instrument, the maturity date of the rate swap instrument would precede the maturity date of the associated risk-free combo. Rather than having periodic settlement, this instrument would settle once upon maturity of the rate swap instrument. Upon creation, a strike price would be set such that the strike price of the rate swap instrument acts as the previous swap rate y_{S,n+1}. At maturity, the formula for the settlement cash flow dₙ applies, but is now calculated based on the current swap rate and the strike price.

Debtors' securitization activity is subdivided into asset classes, so that separate standardized collateral requirements and covenants may be established for different kinds of assets. Mortgage securitization carries separate risks and warrants separate treatment from, say, auto loan securitization. The exchange's risk management operation establishes collateral requirements for each asset class. This basic control creates minimum standards to ensure that the risks associated with these asset classes are accessible and predictable by all participants.

If the exchange's goal is to maximize returns to the synthetic risk-free instrument, then there are well-defined targets for these minimum collateral standards. By raising standards, the exchange lowers the risk of default, but at the same time lowers the returns to creditors. Likewise, lowering standards raises returns and the risk of default. To maximize risk-free returns, the exchange should set standards to where the price effects on the debt and credit derivative instruments offset. This point is where, for small changes in standards, the effects on the prices of these instruments cancel out.

Collateral requirements also serve to establish position limits on debtors on a per asset class basis. To accomplish this, the risk management operation sets marginal collateral requirements to be increasing with position. As debtors' outstanding debt position grows in a particular asset class, the collateral requirements for that class become incrementally more stringent. At some point, the economic cost of the requirements outweighs the benefit to the debtor, and they cease increasing their activity in that particular area. Debtors may participate in multiple asset classes, so that there is a separate limit for each class. A debtor's overall position limit is established from the aggregation of these separate limits.

Another key effect of these collateral requirements is the normalization of the cost of capital across asset classes. To have a single debt instrument tradable by all debtors, there must be a single market-clearing price for that instrument. Marginally increasing collateral requirements accomplish this feat. The economic costs of borrowing grow as debtors' positions grow, and the asset classes which are naturally more profitable become progressively less and less attractive. At the same time, alternative asset classes become relatively more attractive. When the exchange market is in balance, the amount of capital allocated to each asset class is stable, and all debtors bid at the same market clearing price for the debt instrument.

By setting collateral standards, the exchange exerts a degree of control over debtors' behavior. This collateral is the source of debtors' repayments, and standards setting enforces some discipline to the benefit of creditors. These standards aim to make the value of the collateral predictable.

The relevant characteristic of the collateral is its “time-matched unit” value. That is, how much is the collateral worth when the debt instrument (that the collateral secures) matures? The formal collateral requirements are defined in terms of these time-matched units.

A particular asset, a mortgage, for example, consists of a series of expected cash flows that occur over time. Each of these cash flows is considered separately for collateralization purposes. The cash flow for July 2012 collateralizes the July 2012 debt instrument, while the August 2012 cash flow collateralizes that month's maturity group. In this way, every asset may be matched to the monthly maturity groups.

In the general capital market, investors independently chose where to put their money. The amalgamation of their choices results in capital being allocated to its most efficient ends. The debt instrument, too, is a means for allocating capital.

Creditors may choose how much to invest in the debt instrument, but they cannot directly dictate where that money flows. There is no means for creditors to engage in bilateral arrangements with other participants. Creditors' funds are effectively allocated broadly to all debtors. However, by influencing the collateral-based position limits on debtors, individual creditors may control how their investments are put to use.

According to the modern portfolio theory of finance, each creditor's goal is to maximize their returns while minimizing their risks. This theory predicts well-defined diversification targets that maximize the benefits to participants generally.

Creditors are able to invest in the entire “market portfolio” simply by buying the debt instrument. Holding this instrument entitles the creditor to the fully diversified returns across all asset classes. But not all creditors may wish to retain the risk associated with the market portfolio. These participants may transfer that risk to others by purchasing the credit derivative instrument. If a creditor wishes to offload all default risk, they may purchase the debt and credit derivative instruments in equal amounts, so that they are holders of the synthetic risk-free instrument.

Because creditors may invest in the market portfolio and in a risk-free asset, there is a well-defined target for asset class diversification. Specifically, creditors should set collateral limits to create an optimal tangency portfolio, as defined by portfolio theory. Creditors may then individually choose the proportion of the market portfolio and the risk-free asset they wish to hold. No matter what their risk preferences are, they have the profit maximizing capital allocation for that risk tolerance.

To this end, the exchange employs a mechanism to aggregate the preferences of all participants, through which creditors may influence debtor position limits. By this mechanism, creditors may collectively reach an optimal portfolio decision. In one embodiment of this mechanism, it is contemplated that creditors may institute a voting mechanism by which they express and aggregate their preferences. In another embodiment of this mechanism, it is contemplated that the exchange may institute a mechanism for aggregating preferences based on the prevailing trade prices of the various instruments.

When debtors sell debt instruments, they are required to post collateral in accordance with the covenants of the various asset classes defined for the exchange. In general, debtors must meet or exceed the minimum requirements of a specific collateral formula that governs their total exposure across all asset classes. Collateral that falls under the minimum requirement for a given debt instrument position is off-limits for the duration of the position. That is, once collateral is committed, debtors may not access, sell, or otherwise alter the collateral on their balance sheets until the debt instrument matures or is repurchased early.

In one embodiment of the invention, the debtor participants maintain wholly-owned subsidiary entities, one for each asset class in which they do business. The subsidiary model is conceptually clean, but it is not necessarily crucial that debtors organize in this way. What's important is that collateral assets are somehow “on deposit” with the exchange clearinghouse, and that the collateral covenants for each asset class are well-defined and enforceable.

A generic conveyance transaction would proceed as follows. The debtor subsidiary sells a number of debt instruments on the exchange and receives cash. This cash is then used to purchase the collateral assets from the debtor. Excess cash from this transaction may be retained by the subsidiary as additional collateral or transferred to the debtor as part of the asset purchase. Over time, the cash flows from the collateral assets are used to pay the settlement prices of the debt instruments as they mature.

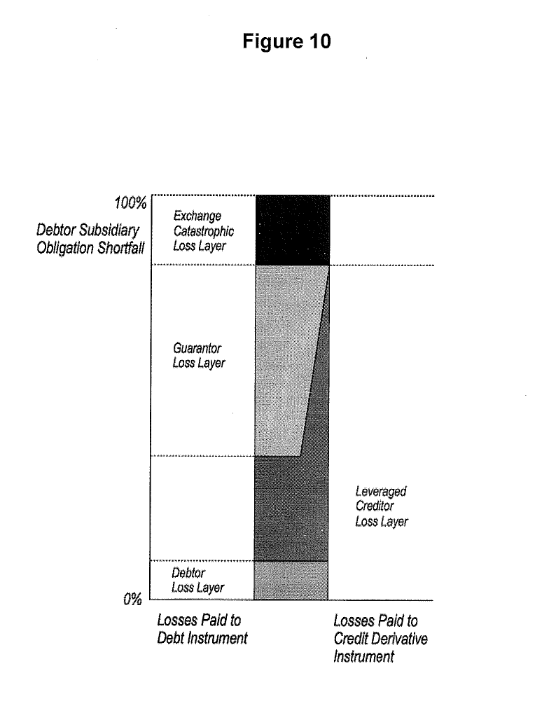

Depending on the variability of cash flows and other factors, the debtor subsidiary may exhaust its cash supply. The available cash is used to settle the maturing debt instruments, to the extent possible. The difference between this cash amount and the full notional value owed is called the “debtor subsidiary obligation shortfall” as shown in FIG. 10. A shortfall event constitutes default, and triggers loss payments from other parties. These payments are used to settle either the debt instrument or credit derivative instrument. As seen in the diagram of FIG. 10, the loss layer structure of default is as follows:

Loss payments from the leveraged creditor layer are used to settle the credit derivative instrument. Loss payments from the debtor, guarantor, and catastrophic layers are used to settle the debt instrument.

After a default event settles, the debtor subsidiary continues as a going interest. Future maturities may not have cash shortfalls, or shortfalls may snowball. In any event, participants in a given maturity group have no further claims or obligations on a subsidiary's cash flows once that particular set of instruments has settled.

The parent debtor is responsible for the first loss layer on its subsidiaries. Losses in this range are paid by the debtor, and the payments accrue to debt instrument holders. This layer provides an incentive for debtors to structure their subsidiaries so as to avoid losses and prevent default.

Losses that exceed a parent debtor's maximum obligations for a particular maturity group become the responsibility of leveraged creditors. That is, the parent debtor's obligations are capped. If a parent debtor fails to fully meet this limited loss obligation for some reason (e.g. firm insolvency), then the first loss obligation also falls to leveraged creditors. However, any portion of this obligation paid by leveraged creditors accrues to credit derivative holders.

In other words, if losses are small, they are fully covered by the parent debtor. The debt instrument is fully settled and there is no settlement payment on the credit derivative instrument. However, if the debtor does not completely cover the losses, then the settlement payment of the debt instrument is reduced by the appropriate amount, and payments are triggered on the credit derivative instrument.

Holders of the credit derivate instrument associated with a particular debt instrument are paid as part of the settlement process when losses exceed debtors' obligations or ability to pay. The creditors who sold these instruments are responsible for this payment.

The maximum settlement value of the credit derivative instrument is some percentage of the debt instrument face value. In other words, the debtor and leveraged creditor loss layers constitute some portion of the “debtor subsidiary obligation shortfall” structure. The remaining portion of the loss structure always pays out to the debt instrument. This fact is important when considering the exchange's risk controls for creditors.

Each leveraged creditor has a long position in debt instruments, and a short position in credit derivative instruments. They are leveraged in the sense that they are funding their debt positions through the sale of credit derivatives, and amplifying their exposure to default. Further, suppose that the exchange wishes to ensure that creditors never owe additional cash at settlement, since such an event would expose the exchange to the credit risk of creditors.

To meet this requirement, all leveraged creditors must receive at least as much in debt instrument settlement payments as they pay out in credit derivative settlement payments. This limits the ratio of credit derivative sold to debt instruments bought by each creditor. In the worst case, where all debtors collectively fail to cover any losses, leveraged creditors shall not receive any cash at settlement, but do not owe any additional cash to the exchange clearinghouse for settlement purposes.

Debtor subsidiaries are required to purchase excess loss coverage from a financial guarantee provider. This provider evaluates the structure of the subsidiary, estimates its risks, and offers coverage to the subsidiary at the appropriate price. This coverage may potentially be provided by an additional instrument created to trade on the exchange. Such an instrument would be effective if it were pegged to the specific risks of individual subsidiaries, since this would elicit deep examination of each entity by coverage providers. Alternatively, guarantors may engage in bilateral financial guarantee agreements with debtors.

The exchange itself provides reinsurance to guarantee providers. In the event a guarantor fails to meet its settlement obligations, the exchange steps in to cover the shortfall. Guarantors are necessarily subject to strict risk management requirements.

The loss layer structure is designed to align the incentives of every participant and protect the integrity of the synthetic risk-free instrument for creditors.

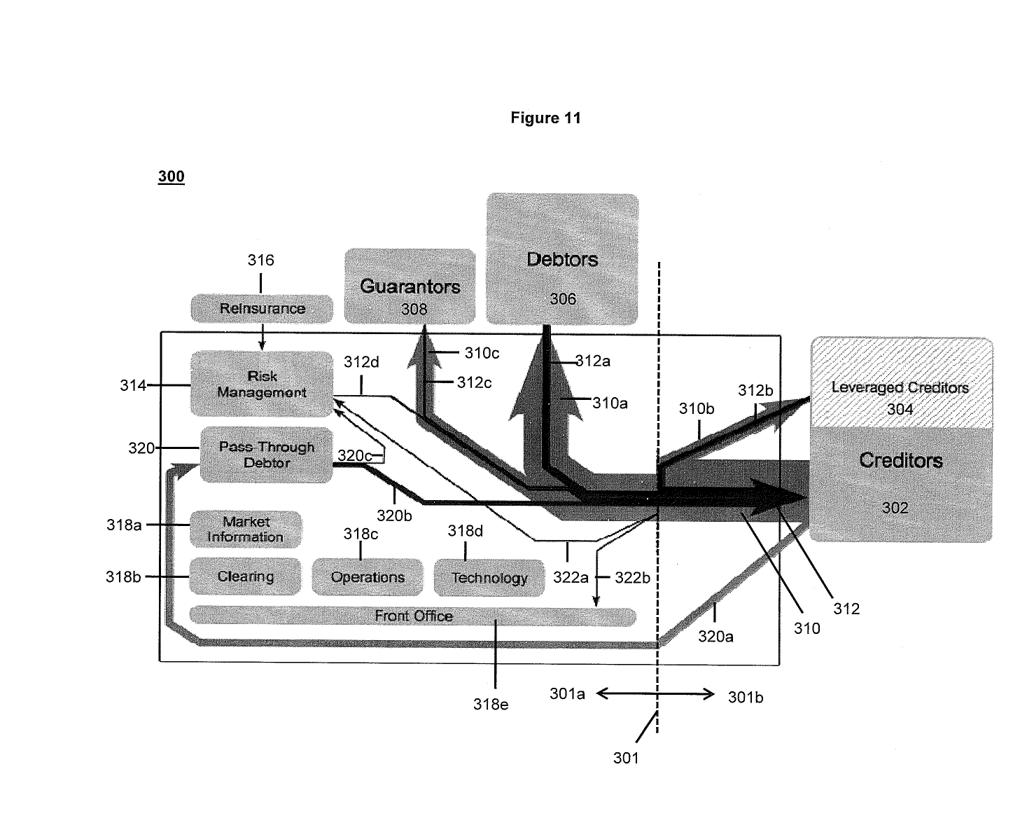

FIG. 11 illustrates the debtor default loss structure 300 of the exchange market according to the invention. The exchange matching engine is illustrated by dotted line 301. The exchange matching engine 301 matches buyer and sellers to a particular instrument in order to conduct transactions. According to the invention, the debt instruments and any underlying instruments are created through the act of trading on the exchange market. The parties subject to collateral requirements are represented by the arrow 301a to the left of 301 and parties that do not deal with collateral are represented by the arrow 301b to the right of 301.

The trade price cash flow paid by creditors is generally represented by arrow 310. Creditors are buyers of the debt instrument and the credit derivative instrument. Specifically, the cash flow for the debt instrument is provided to guarantors 308 and debtors 306 and secured by the underlying collateral and the cash flow for the credit derivative instrument is provided to leveraged creditors 304. Generally speaking, the debt instrument cash flows are capital transfers from creditors 302 to debtors 306, where debtors conduct real economic activity in order to produce collateral assets, while the cash flow for the credit derivative instrument is a financial risk management cash flow. The return-on-investment paid to creditors 302 during settlement is represented by arrow 312. In one embodiment, the return-on-investment paid to creditors 302 is all or a portion of the trade price cash flow plus interest. Arrow 312 generally represents the sources of settlement cash flows in the debtor default loss structure 300, specifically arrow 312 represents an aggregation of cash flow 312a from the debtor 306, cash flow 312b from leveraged creditors 304 (via the credit derivative instrument), cash flow 312c from guarantors 308, and the cash flow 312d from the exchange risk management entity 314. Essentially the cash flow 312d from the exchange risk management entity 314 is a catastrophic guarantee explained more fully below.

As shown in FIG. 10, leveraged creditors 304 receive trade price cash flows as illustrated by arrow 310b and pay settlement cash flows as illustrated by arrow 312b. Arrow 312b represents the leveraged creditors 304 obligation as part of the debtor default loss structure 300. To the extent that leveraged creditors 304 are holders of the debt instrument, they are considered creditors and the debt instrument portion of their holdings is represented by 310.

Debtor cash flows are represented by arrows 310a and 312a. Specifically, arrow 310a represents the portion of the debt instrument trade cash flow that goes to debtors via their relationship with creditors 302. Arrow 312a represents all or a portion of the debt instrument paid by debtors 308 to creditors 302.

Guarantor cash flows are represented by arrows 310c and 312c. Specifically, arrow 310c represents the portion of the debt instrument trade cash flow that goes to guarantors via their relationship with debtors 306. Arrow 312c represents all or a portion of the debt instrument paid by guarantors 308 to creditors 302 in the event of debtor default.

The risk management entity 314 resides within the exchange market and oversees risk management, collateral, and market participants. Risk management entity 314 includes a cash flow 312d to account for a catastrophic guarantee. Cash flow 312d represents payment of all or a portion of the debt instrument settlement by the risk management entity 314 in the event of catastrophic loss.

As a financial resource of last resort for market participants, the exchange clearinghouse may seek additional financial support from outside entities. Reinsurance entity 316 represents outside financial support which the exchange clearinghouse may contract for catastrophic debtor default insurance. Cash from such arrangements enters the debtor default loss structure 300 through the risk management entity 314, specifically as represented by arrow 312d.

Other exchange entities include department such as a market information department 318a that may provide market data to participants and outside parties. A clearing department 318b function as the middle and back office clearing operations of the exchange. An operations department 318c manages trading operations. Specifically, the operations department 318c manages the daily operation of the electronic exchange market. A technology department 318d provides information technology and a front office department 318e represents the remainder personnel and organization of the exchange market.

Creditors 302 may acquire a position in the debt instrument through an alternative means, for example, by directly conveying certain high-quality collateral assets to the exchange entity known as the pass-through debtor 320. For example, creditors 302 may convey United States treasury bonds directly to the pass-through debtor 320 as represented by arrow 320a. This transaction results in a long debt instrument position for the creditor 302, and a short debt position for the pass-through debtor 320. It is contemplated that the pass-through debtor 320 may be provided by the exchange market itself to create a debt instrument position in the absence of debtors 306. Pass-through debtor settlement cash flow as shown by arrow 320b represents the settlement cash flow backed by the collateral conveyed to the pass-through debtor 320.

Transaction fees 322 are contemplated within the debtor default loss structure 300. For example, a risk management transaction fee as represented by arrow 322a may be a per transaction fee charged to market participants 302, 304, 306, 308. It is contemplated that the risk management transaction fee may fund the catastrophic cash flow 312d. As another example, an exchange transaction fee as shown by arrow 322b may be a general per transaction fee charged by the exchange clearinghouse to fund operations. The exchange transaction fee may be the primary source of revenue to the exchange market. Yet another example may be a risk management pass-through fee as shown by arrow 320c. The risk management pass-through fee may be charged to market participants via the settlement process for the pass-through debtor 320 such that all or a portion of the settlement cash flow (generally shown by arrow 322) is redirected to fund the catastrophic cash flow 312d.

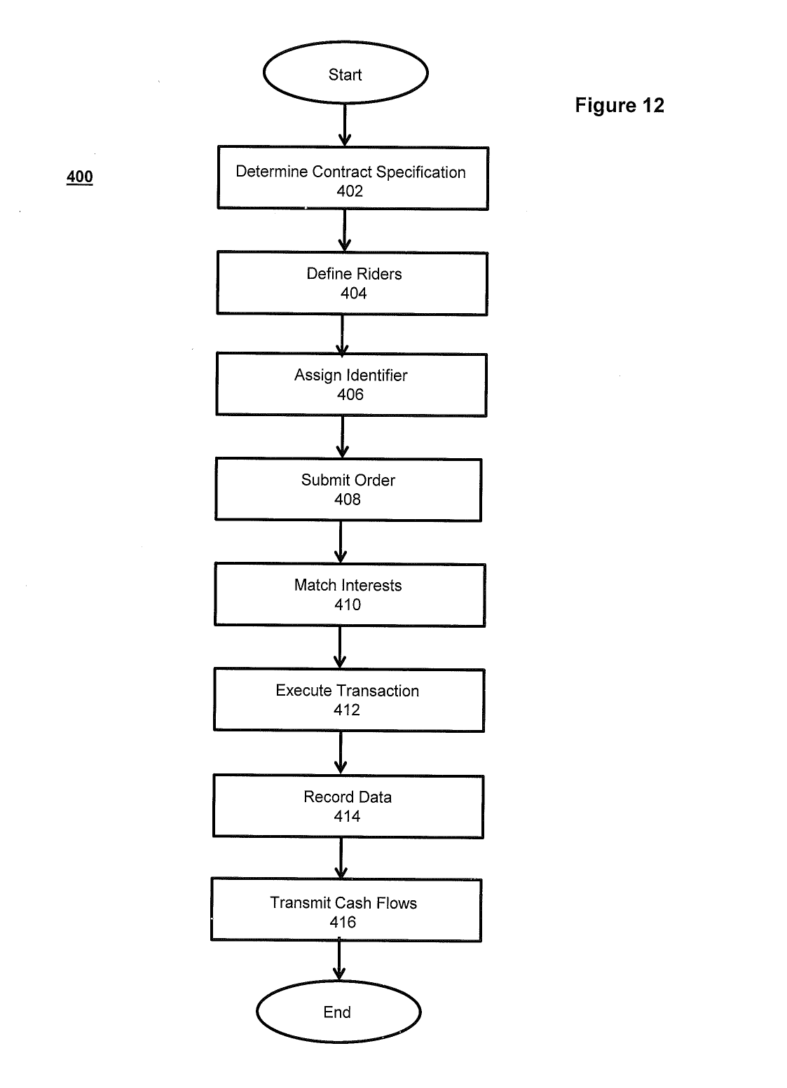

FIG. 12 illustrates a flow chart according to a method 400 for creating an instrument according to one embodiment of the invention. An instrument is first defined by the exchange via a contract specification. An instrument is first defined by the exchange via a contract specification at step 402. The contract specification defines all of the rights and obligations of market participants who transact on the exchange, as well as the rights and obligations of other entities that facilitate such transactions, such as a clearinghouse.

The contract specifications for the various instruments—the debt instrument, credit derivative instrument, and rate swap instrument—are different as described herein. It is contemplated that any additional specifications may be defined as warranted by the particular circumstances of the instrument.

The exchange allows for multiple, distinct versions of each instrument by leaving undefined certain elements of the contract specifications. For example, a debt instrument contract specification may define the concept of a maturity date, but refrain from defining the specific maturity date of the instrument.

The contract specifications further allow for riders to be defined at step 404. Riders provide the remainder of the instrument characteristics, thereby providing a means for the creation of particular contract specifications. For example, the rider may specify the maturity date of a debt instrument. Instruments created through different riders are considered distinct instruments, and are thus not interchangeable. From time to time, the exchange and market participants may amend either the contract specifications and/or the riders for new types of instruments. Contract specifications may be formulated by means of electronically registering the specification details in an exchange computer system such as that as described in reference to FIG. 1.

A unique identifier may be assigned at step 406 and stored along with the associated details of the contract specification and any riders. Instruments sharing a common unique identifier are considered identical and interchangeable, whereas instruments with differing identifiers are considered distinct.

Market participants may assume rights and obligations under these contract specifications by means of electronic communications on the exchange computer system. As defined previously, market participants may indicate an interest in assuming such rights and obligations by electronically submitting orders at step 408.

At step 410, two or more market participants with similar interests are matched such that a transaction occurs at step 412. The transaction at step 412 may involve one or more instruments. In the case of multiple instruments, the instruments may be several identical instruments, several distinct instruments, or a mixture of both. The transaction occurs by means of recording the transaction details in the exchange computer system, as well as transmitting the details electronically to the market participants involved. In addition, a subset of the transaction details may be transmitted electronically to other market participants, or to other outside parties.

The transaction represents the assumption by market participants of certain rights and obligations under the particular instrument or instruments involved in the transaction. For each instrument transacted, exactly one market participant shall assume the rights and obligations as the buyer of that contract, while exactly one other market participant shall assume the rights and obligations as the seller of that contract, such that all instruments transacted are assigned a buyer and seller. The exchange additionally assumes certain rights and obligations as defined by the contract specification of each instrument.

The aggregation of buyer and seller rights and obligations of each market participant are recorded electronically in the exchange computer system at step 414. In the case of the assumption of buyer rights and obligations of a particular instrument, an electronic record is made which increments the aggregate number of instruments with this unique identifier in the account of the market participant. In the case of the assumption of seller rights and obligations of a particular instrument, an electronic record is made which decrements the aggregate number of instruments with this unique identifier in the account of the market participant. In this way, a market participant may offset aggregated buyer rights and obligations in a particular instrument by assuming seller rights and obligations of an identical instrument. The converse is also true.

Because each instrument creates a contractual relationship between the market participants and the exchange, but not directly between market participants, the off-setting of identical and interchangeable instruments may proceed without regard for the identity of the participants in prior transactions. An instrument exists when both a market participant has assumed the buyer rights and obligations for that instrument and when another market participant has assumed the seller rights and obligations for that instrument.

Thus, the electronic trading network shall, at all times, maintain an equal number of buyer rights and obligations and seller rights and obligations for each unique contract specification. According to the invention, an instrument comes into existence through the act of transacting electronically via the electronic trading network. Likewise, an instrument is eliminated through the act of transacting electronically via the exchange computer system.

During a transaction, in addition to the assumption of rights and obligations under the contract specifications for the transacted instruments, there are cash flows between buyers and sellers of each instrument. Such cash flows are recorded electronically in the electronic trading network, and transmitted to the appropriate common financial institution in which the market participants maintain accounts, such as a clearinghouse, at step 416. This common financial institution, being a party to the contract specifications, shall debit and credit the appropriate accounts of market participants so as to affect the transfer of cash.

Generally, the buyer of an instrument in a transaction shall pay the cash flow, known as the trade price, and the seller of an instrument shall receive the cash flow. However, there is no restriction as to which participant pays or receives the cash. In the case when the seller of an instrument pays the cash flow, and the buyer of the instrument receives the cash flow, the trade price shall be considered negative. In the case when no cash flow occurs, the trade price shall be considered zero. In all cases the amount of cash paid shall be identical to the amount of cash received for a given instrument transaction.

The contract specifications of each instrument may additionally require actions by the market participants who have assumed rights and obligations under those instruments. Such action may or may not take place via the electronic trading network. In particular, the contract specifications for debt instruments require the posting of collateral by market participants who have assumed rights and obligations as sellers of such instruments. The general process for posting collateral by sellers of the debt instrument, also known as debtors, is as follows.

At some time following the transaction of debt instruments in which the net aggregate amount of various debt instruments has increased, debtors may have to modify the amount of collateral posted with the exchange, or agent of the exchange, such as a clearinghouse. The specific collateral obligations of the debtor are determined by the contract specifications between the exchange and the debtor.

In general, the debtor is required to increase the amount of collateral posted with the exchange when the net aggregated amount of outstanding debt instruments has increased. Collateral is generally defined as the rights to cash flows. The purpose of such collateral is to provide a means by which the debtor meets the settlement cash flow obligations assumed via the debt instrument. To post collateral means to convey assets to the exchange, or to some entity on behalf of the exchange, such that the conveyance of these assets constitutes a true sale under generally accepted accounting principles. If conveyed to an entity, that entity may be known as a special purpose entity. The cash flow from the debt instrument trade price shall be considered the purchase price of the collateral assets.

As defined previously, collateral assets may be split into various classes, such that each asset class will have its own specifications for what constitutes collateral for that class. As with contract specifications, the concept of asset classes may be defined in the contract specifications, while the specific elements of each asset class may be defined in riders to the contract specifications.

A debtor may be approved to post various asset classes as collateral. Generally, the debtor may decide which asset classes to post, however the required aggregate level of collateral across assets shall be governed by the several asset class specifications. Once conveyed to the exchange or special purpose entity, collateral may not generally be withdrawn.

A debtor may reduce the number of debt instruments outstanding from time to time in the event that certain collateral assets produce cash flows or otherwise change status such that the aggregate level of collateral posted exceeds the requirements of the several asset class specifications. In this event, cash held at the exchange or special purpose entity as collateral for the debtor's aggregate debt instrument position may be used to transact on the exchange, where the aggregate debt instrument position is reduced through the purchase of debt instruments on the exchange.

While this disclosure is susceptible to various modifications and alternative forms, specific exemplary embodiments thereof have been shown by way of example in the drawings and have herein been described in detail. It should be understood, however, that there is no intent to limit the disclosure to the particular embodiments disclosed, but on the contrary, the intention is to cover all modifications, equivalents, and alternatives falling within the scope of the disclosure as defined by the appended claims.

1. A computer implemented method for trading an exchange listed financial instrument between one or more parties, the method comprising the steps of:
executing a trade of the exchange listed financial instrument for which a cash value of the instrument is used to purchase one or more collateral assets;
submitting the exchange listed financial instrument for settlement on a maturity date; and
determining a collateral asset cash flow to pay a settlement price of the exchange listed financial instrument on the maturity date,
wherein said executing step, said submitting step, and said determining step are executed by one or more processors.

2. The method of claim 1, wherein said executing step further comprises:
receiving a first order to buy or sell the exchange listed financial instrument, wherein the exchange listed financial instrument is priced relative to the one or more collateral assets as determined by a collateral asset calculation; and
matching the first order with a complementary second order to sell or buy the exchange listed financial instrument relative to the collateral asset calculation.

3. The method of claim 2, wherein said executing step accommodates one or more bids or offers describing a number of shares of the exchange listed financial instrument and at market or at a limit price.

4. The method of claim 2, wherein the first order is one selected from the group comprising: a market order, a limit order, and an execute-at-close order.

5. The method of claim 1, wherein said executing step further comprises at least one of computing the cash value at or after a specified time, receiving the cash value at or after a specified time, and delivering the cash value at or after a specified time.

6. The method of claim 1, wherein the specified time is at or relative to a closing time for an exchange.

7. The method of claim 1, wherein the collateral asset cash flow is reduced when there is a default.

8. The method of claim 7, wherein one or more fees fund the reduction in the collateral asset cash flow.

9. The method of claim 7, wherein the default triggers one or more loss payments from the one or more parties.

10. The method of claim 9, wherein the one or more loss payments are used to settle the exchange listed financial instrument.

11. The method of claim 9, wherein the one or more loss payments are used to settle a credit derivative instrument.

12. A computer-based system for trading an exchange listed financial instrument for which a trade price can be calculated on or away from an exchange, the system comprising:
a first client device configured to enter trade information;
an exchange host system configured to receive the trade information, wherein the exchange host system executes the trade of the exchange listed financial instrument for which an instrument value is calculated and published at or after a specified time; and
a second client device to receive information related to the instrument value and trade cash flow as determined by the exchange host system, wherein the exchange host system further records the obligation to pay a principal cash flow at a future maturity date of the exchange listed financial instrument.

13. The computer-based system of claim 12, wherein the instrument value may be used to purchase one or more collateral assets.

14. The computer-based system of claim 12, wherein the instrument value is determined according to a collateral asset calculation relative to the one or more collateral assets.

15. The computer-based system of claim 12, wherein the specified time is at or relative to a closing time for an exchange.

16. The computer-based system of claim 12, wherein the principal cash flow is reduced when there is a default.

17. The computer-based system of claim 16, wherein one or more fees fund the reduction in the principal cash flow.

18. The computer-based system of claim 16, wherein the default triggers one or more loss payments from the one or more parties.

19. The method of claim 18, wherein the one or more loss payments are used to settle the exchange listed financial instrument and any underlying instruments.

20. A debt instrument for managing default risk that is traded on an exchange between a first party and a second party, comprising:
a trade date, wherein said trade date is the date on which the debt instrument is traded on the exchange;
a maturity date, wherein said maturity date is the date on which a principal amount associated with the debt instrument is due;
a trade price, wherein said trade price is determined by the market and transferred from the first party to an exchange clearinghouse and said trade price is transferred from the exchange clearinghouse to the second party on said trade date;
a face value, wherein said face value is transferred from the second party to the exchange clearinghouse on said maturity date; and
a settlement value, wherein said settlement value is transferred from the exchange clearinghouse to the first party on said maturity date.
